(19) United States
(12) Patent Application Publication
(10) Pub. No.: US 2008/0101080 A1
(43) Pub. Date: May 1, 2008

(54) Electroluminescent film composite for the entry region of a vehicle and vehicle equipped with it

(76) Inventor: Peter Hein, Denkendorf (DE)

Correspondence Address: COLLARD & ROE, P.C., 1077 NORTHERN BOULEVARD, ROSLYN, NY, 11576, US

(21) Appl. No.: 11/975,178

(22) Filed: Oct. 18, 2007

(30) Foreign Application Priority Data
Oct. 25, 2006 (DE) 10 2006 050 327.9

(51) Int. Cl. B60Q 1/00

(52) U.S. Cl. 362/488

(57) ABSTRACT

An electroluminescent (EL) film composite for attachment in the entry region of a motor vehicle, particularly on thresholds, running boards, and doorsills. The friction wear protection is rigidly integrated into the film composite, i.e. connected with the other layers of the composite in planar manner, for example in that a friction-wear-resistant protective film is already applied during production of the composite, via gluing, hot-lamination, or a similar method. Alternatively or additionally, a friction-wear-resistant coating layer can be applied, also already during production of the composite. The EL film has an electroluminescence structure composed of a luminescent pigment layer that is disposed between a front and rear electrode layer, in each instance. The electroluminescence structure is surrounded on both sides with an insulating film, in each instance. On the underside, the composite has an adhesive layer, and is fixed in place on a carrier material with the adhesive layer. The top-side insulating film also fulfills the task of a protective film.

### CROSS REFERENCE TO RELATED APPLICATIONS

Applicant claims priority under 35 U.S.C. §119 of German Application No. 10 2006 050 327.9 filed Oct. 25, 2006.

### BACKGROUND OF THE INVENTION

1. Field of the Invention

The present invention relates to an electroluminescent film composite. In particular, the invention relates to an electroluminescent film composite for attachment in the entry region of a motor vehicle to decorate the entry and facilitate entering the vehicle in the dark. The electroluminescent film composite has an upper electrode layer, a lower electrode layer, a luminescence layer disposed between the upper and the lower electrode layer, and an adhesive layer on the underside. Furthermore, the invention relates to a motor vehicle equipped with such a film composite.

2. The Prior Art

Electroluminescent film composites, referred to by the abbreviation EL films in the following, are design elements in automobile construction that are used in many different ways. For example, they serve for backlighting of the car roof lining, or of dashboards. For some years now, they have also been affixed in the entry region of automobiles, particularly on thresholds, running boards, and doorsills, in order to decorate the entry and facilitate entering the car in the dark.

In this connection, film composites of the type stated initially are integrated into the entry region, for example as described in the German utility model DE 201 03 133 U1 or in the German Offenlegungsschrift DE 103 20 467 A1, in such a manner that they are either completely recessed into the entry threshold, or are covered on the top with a metal or plastic shutter. Such a shutter is required in order to protect the EL film from scratches and impact stresses, such as those that unavoidably occur due to contact with the shoes of car passengers who are getting in or out. Entry strips lighted with EL films, which strips have a simple structure, as they are already available in the discount trade, also cannot make do without separate protective covers, such as injection-molded plastic parts or metal strips.

The separate covers make lighting the entry region more expensive, and they cause significant effort in installation. EL films in the entry region that are provided as standard equipment require a suitably designed environment, in order to guarantee sufficient scratch and impact protection. After-market film composites of the type stated initially require a clearly elevated structure, as compared with the surroundings. This structure can result in fit problems, for one thing, and there is the risk of getting caught on them when getting in and out.

### SUMMARY OF THE INVENTION

With the background of the set of problems described, it is an object of the present invention to provide the lighting of a vehicle entry using electroluminescence in a simpler and more cost-advantageous manner, and, in this connection, to particularly reduce the installation effort, without having to do without sufficient friction wear protection.

These and other objects are achieved, according to one aspect of the present invention, by an electroluminescent film composite for attachment in the entry region of a motor vehicle having an upper electrode layer, a lower electrode layer, a luminescence layer disposed between the upper and the lower electrode layer and an adhesive layer on the underside. The film composite has a friction-wear-resistant, at least partially transparent protective layer as the uppermost layer, which is connected with the remainder of the composite over its entire area.

Preferred embodiments are discussed below.

Instead of a separate shutter, the friction wear protection is rigidly integrated into the film composite, i.e. connected with the other layers of the composite in planar manner, for example in that a friction-wear-resistant protective film is already applied during production of the composite, via gluing, hot-lamination, or a similar method. Alternatively or additionally, a friction-wear-resistant coating layer can be applied, also already during production of the composite. A coating layer is understood to be a layer that is applied in the flowable or pourable state, and not in the form of a film body, for example by imprinting, spraying, spreading, powder-coating or casting.

The film composite may be configured as an entry strip. A carrier film may be disposed underneath the lower electrode layer. The carrier film may be made predominantly of poly(ethylene terephthalate)(PET).

The protective layer may be structured as a protective film made predominantly of polyvinyl chloride material or polyurethane material having a thickness of at least 75 μm.

The protective layer may be a coating layer. The coating layer may be cast, spread on or sprayed on, or printed on. The coating layer may consist of a polyurethane material, such as a polyurethane resin, or a texture or relief varnish.

The coating layer may be produced from an application agent that has a flow limit of more than 50 Pa when it is applied to the surface. The coating layer may have a thickness of at least 50 μm and may be enriched with solid particles such as rubber particles, glass particles, or support pigments.

The free surface of the protective layer may be hardened with electron beams or textured. At least one decorative element may be integrated into the film composite underneath the protective layer. The decorative layer may have a metallic effect.

The decorative element may represent a mask for the formation of graphic and/or alphanumeric symbols and may be translucent or printed.

The upper electrode layer, lower electrode layer, and luminescence layer may be structured over only part of the area or spaced apart from an edge of the film composite by at least one millimeter, all around.

It is surprising for a person skilled in the art that a protective layer having a thickness of less than 100 micrometers, preferably less than 40 micrometers, is alone able to offer sufficient friction wear protection. This protection can be further improved by electron-beam hardening of the surface or nanoparticle coatings. As compared with commercially available plastic covers, there is furthermore a clearly increased impact resistance; in particular, the risk of splintering due to brittleness caused by cold in winter no longer exists. The surface can be kept permanently dirt-free by means of nanotexturing.

As compared with the state of the art described above, there is the advantage that the film composite can be glued on at the desired application location in one working step, and, at the same time, the material expenditure is slight. The film composite according to the invention is generally more flexible and clearly thinner than a metal or plastic shutter (according to an advantageous embodiment, having a bending resistance of less than 20 mNm, preferably less than 10 mNm, according to DIN 53 121, and a total thickness of less than 3 m, preferably less than 1.5 mm). As a result, the application flexibility is greater, particularly for after-market sets.

Depending on the desired place of application, the film composite is preferably designed to be as step-resistant as possible. In particular, preferably the film composite is designed so that a pressure stress of 7 newtons per square centimeter, preferably 10 newtons per square centimeter, can be absorbed without permanent damage.

According to another aspect, the invention provides a motor vehicle that has an entry region having a film composite as discussed above affixed at step height. The top of the film composite may be free of a separately affixed protective cover. The film composite may be attached to the motor vehicle solely via its underside adhesive layer.

Fundamentally, any variant of the invention described or indicated in the present application can be particularly advantageous, depending on the economic and technical conditions in an individual case. Unless something is stated to the contrary, and to the extent that it is fundamentally technically possible, individual characteristics of the embodiments described can be interchanged or combined with one another, as well as with measures known from the state of the art.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the following, examples of preferred embodiments of the present invention will be explained in greater detail, using the related drawings. In this connection, the drawings are purely schematic, and are not representations to scale, for reasons of better illustration. In particular, relationships of the dimensions relative to one another can deviate from actual embodiments. For example, the thickness of film layers is represented in greatly exaggerated manner.

Elements that correspond to one another are provided with the same reference symbol in the individual figures, to the extent that doing so makes sense.

Individually, the drawings show:

FIG. 1 shows an example of a film composite according to the invention, disposed on a carrier material, in a cross-sectional representation, in which the friction wear protection is implemented via a protective film;

FIG. 2 shows another example of a film composite according to the invention, disposed on a carrier material, in a cross-sectional representation, in which the friction wear protection is implemented via a coating layer;

FIG. 3a shows an example of a film composite according to the invention, disposed on a carrier material, in a cross-sectional representation similar to FIG. 1, but here a circumferential edge is structured to not be electroluminescent;

FIG. 3b shows the film composite from FIG. 3a in a top view; and

FIG. 4 shows an electroluminescent film composite having a protective shutter according to the state of the art.

### DETAILED DESCRIPTION OF PREFERRED EMBODIMENTS

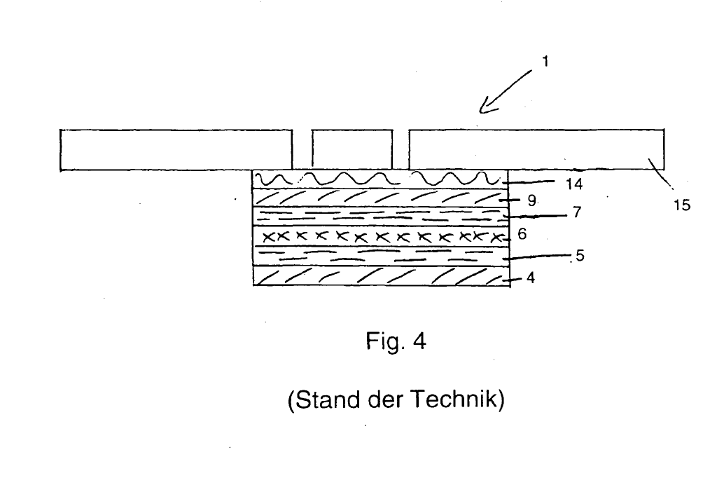

Turning now in detail to the drawings, FIG. 4 shows a conventional entry strip 1. Strip 1 has an electroluminescent film composite below a rigid protective strip 15 made of aluminum or hard plastic, which composite has at least the following layers, underneath a connection layer 14 (generally consisting of an adhesive), with which the film composite is attached to protective strip 15 (from top to bottom in the drawing): transparent film laminate 9, first electrode layer 7, an electroluminescence pigment layer 6, and another electrode layer 5. On the underside, the composite ends with a second film laminate 4.

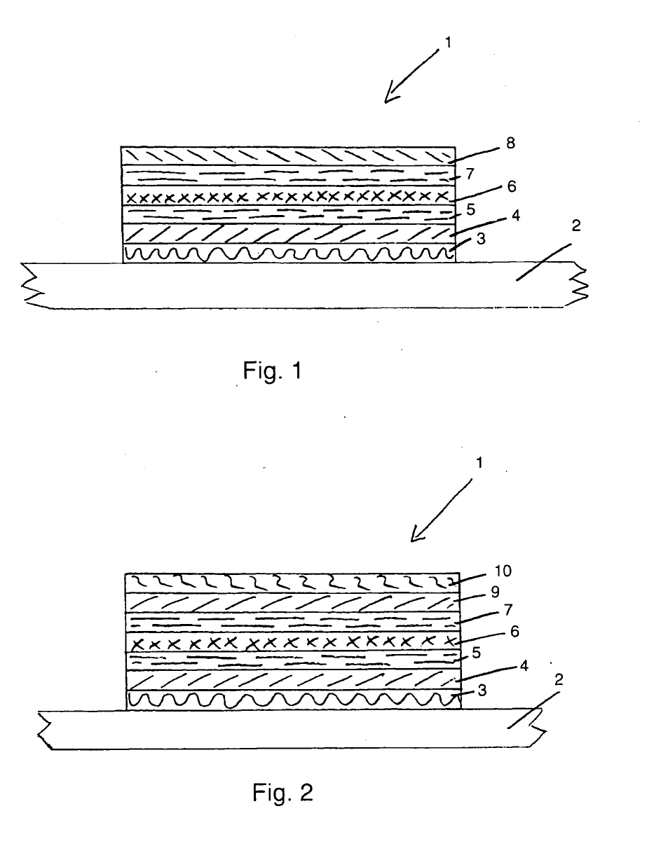

FIG. 1 shows a first preferred embodiment of the present invention. The EL film 1 according to the invention also has a known electroluminescence structure composed of a luminescent pigment layer 6 that is disposed between a front and rear electrode layer 7, 5. The electroluminescence structure ends, on both sides, with an insulating film 4, 8. On the underside, composite 1 has an adhesive layer 3, and is fixed in place on a carrier material 2 with adhesive layer 3.

In place of separate electrode layers 5, 7 of a transparent conductive varnish, silver paste, or carbon paste, or the like, for example, electrically conductive sputter or vapor-deposited films 4, 8 can also be used. Contacting of electrode layers 5, 7 can take place, for example, by so-called bus bars of suitable conductive pastes or metal films. Insulation of electrode layer 5, 7 on the film edge, with regard to the surroundings, is not shown but is necessary.

In addition to the layers listed, various other film layers such as dielectrics, vapor barriers, optical filters, and the like can also supplement the structure, if necessary, in advantageous manner, and might even be necessary for special application cases.

Insulating film 8 on the top also fulfills the task of a protective film 8. It is characterized in that it has sufficient step resistance and friction wear resistance to withstand constant stress caused by people stepping on it. Suitable materials for protective film 8 are, in particular, films made from polyvinyl chloride (PVC) or polyurethane (PU). Preferably, a protective film 8 having a thickness of at least 75 μm, particularly preferably at least 100 μm, is used. A double-layer or multi-layer protective film 8 is also possible.

Materials that are particularly suitable for the formation of the protective film, depending on the application case, are, for example, a highly transparent polyurethane (PU) film with a thickness of 100-300 μm available under the name Schreiner ProTech 3S film or a PVC-film, black/shagreened with a thickness of 145 μm available under the name Schreiner No. 47 001269_{—}01. A partially transparent PVC material, scarred with black, available from RITRAMA S.p.A., for example, with acrylate permanent adhesive as the connection layer, is also well suited.

A second preferred embodiment of the invention is shown in FIG. 2. The EL film 1 shown here is essentially analogous in structure to the EL film 1 shown in FIG. 1; however, the upper two layers 9, 10 replace the protective film 8 from FIG. 1. In this connection, layer 9 represents any desired film 9 that electrically insulates the electroluminescence structure towards the top, such as the films that are usually used for electroluminescence structures according to the state of the art, for example. The decisive factor for the friction wear protection is now the coating layer 10 on the top of film 9. Coating layer 10 increases the step resistance and friction wear resistance, just like the protective film 8 in FIG. 1 does. Materials that achieve a certain minimum material thickness, preferably above 50 μm, when they are applied, have proven themselves as particularly well suited coating layers, in order to appropriately absorb steps. Polyurethane resins, which can be cast onto the component, and so-called texture or relief varnishes, are particularly advantageous. Such varnishes have a high flow limit, which lies at at least 50 Pa, in order to be able to produce a desired relief structure, using the screen-printing method.

A material that is particularly suitable for forming coating layer 10, depending on the application case, is a so-called step protection varnish, particularly a step protection varnish that is a colorless (transparent) UV-lacquer available under the name Nori Cure UVL 3. Transparent casting masses available under the name Plastoclear are also particularly well suited.

Furthermore, the application agents that form coating layer 10 can be enriched with additional solids, for example with rubber particles, glass particles, or other so-called support pigments, whereby these preferably have a Mohs hardness of 6 or greater, in order to produce a stable layer that is particularly step-resistant and friction-wear-resistant. The surface of coating layer 10 is preferably not smooth, but rather textured, and prevents uncontrolled slipping on it.

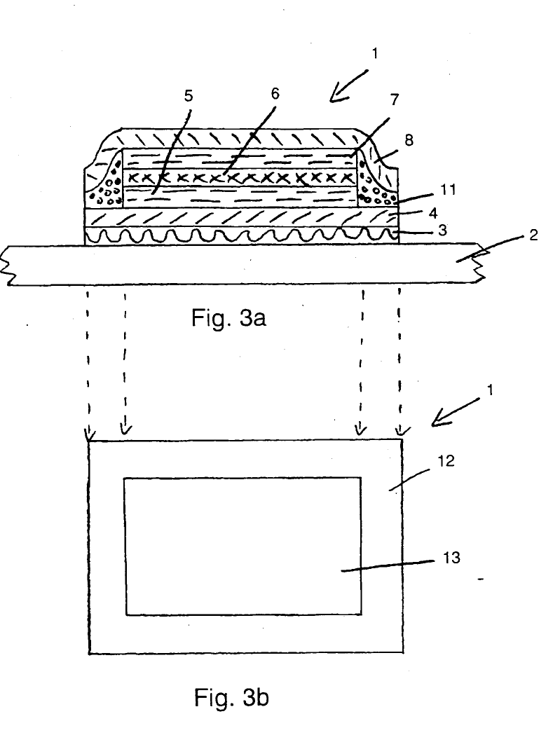

FIGS. 3a and 3b show a film composite 1 extensively structured as in FIG. 1. Here, however, the luminescent pigment layer 6 and electrode layers 5, 7 do not extend all the way into the circumferential edge region 12, but rather are limited, in terms of their expanse, to the central luminescent region 13, which can also have curved edges, for example, for its optical design. Several luminescent regions 13 disposed next to one another are also possible. In edge region 12, which can preferably have a width of one or more millimeters, the protective film 8 is directly glued to the underside insulating film 4, by way of the adhesive 11.

The combination of a suitable top-side protective layer 8, 10 and an adhesive 3 applied on the underside leads to a lighting element that is easy to apply but nevertheless stable and robust. Furthermore, an optically attractive component can be produced via graphic effects such as an imprint of a translucent metal effect layer that has an opaque effect towards the outside (not shown) underneath the top-side protective layer 8, 10, which component demonstrates high product quality, despite a clearly reduced cost expenditure.

Although only a few embodiments of the present invention have been shown and described, it is apparent that many changes and modifications may be made thereunto without departing from the spirit and scope of the invention.

What is being claimed is:

1. An electroluminescent film composite for attachment in An entry region of a motor vehicle, comprising:
(a) an upmost layer forming a friction-wear-resistant and at least partially transparent protective layer; and
(b) a remaining film composite comprising an upper electrode layer, a lower electrode layer, a luminescence layer disposed between the upper electrode layer and the lower electrode layer, and an underside adhesive layer;
wherein said upmost layer is connected to the remaining film composite over an entire area of said upmost layer.

2. The film composite according to claim 1, wherein the film composite is configured as an entry strip.

3. The film composite according to claim 1, further comprising a carrier film disposed underneath the lower electrode layer.

4. The film composite according to claim 1, wherein the protective layer comprises a protective film.

5. The film composite according to claim 4, wherein the protective film is made predominantly of polyvinyl chloride material.

6. The film composite according to claim 4, wherein the protective film is made predominantly of polyurethane material.

7. The film composite according to claim 4, wherein the protective film has a thickness of at least 75 μm.

8. The film composite according to claim 1, wherein the protective layer is a coating layer.

9. The film composite according to claim 8 wherein the coating layer is cast.

10. The film composite according to claim 8, wherein the coating layer is spread on or sprayed on.

11. The film composite according to claim 8, wherein the coating layer is printed on.

12. The film composite according to claim 8, wherein the coating layer comprises a polyurethane material.

13. The film composite according to claim 8, wherein the coating layer comprises a texture or relief varnish.

14. The film composite according to claim 8, wherein the coating layer is produced from an application agent that has a flow limit of more than 50 Pa when applied to a surface.

15. The film composite according to claim 8, wherein the coating layer has a thickness of at least 50 μm.

16. The film composite according to claim 8, wherein the coating layer is enriched with solid particles.

17. The film composite according to claim 16, wherein the solid particles comprise rubber particles, glass particles, or support pigments.

18. The film composite according to claim 1, wherein the protective layer has a free surface hardened with electron beams.

19. The film composite according to claim 1, wherein the protective layer has a textured free surface.

20. The film composite according to claim 1, wherein at least one decorative element is integrated into the film composite underneath the protective layer.

21. The film composite according to claim 1, wherein the upper electrode layer, the lower electrode layer, and the luminescence layer are partially structured.

22. The film composite according to claim 21, wherein the upper electrode layer, the lower electrode layer, and the luminescence layer are spaced apart from an edge of the film composite by at least one millimeter, all around.

23. A motor vehicle comprising an entry region having an electroluminescent film composite affixed at step height, the electroluminescent film composite comprising an upmost layer forming a friction-wear-resistant and at least partially transparent protective layer, and a remaining film composite comprising an upper electrode layer, a lower electrode layer, a luminescence layer disposed between the upper electrode layer and the lower electrode layer, and an underside adhesive layer, wherein said upmost layer is connected to the remaining film composite over an entire area of said upmost layer.

24. A motor vehicle according to claim 23, wherein the film composite has a top free of a separately affixed protective cover.

25. A motor vehicle according to claim 23, wherein the film composite is attached to the motor vehicle solely by the underside adhesive layer.
